(19) United States
(12) Patent Application Publication
(10) Pub. No.: US 2021/0224083 A1
(43) Pub. Date: Jul. 22, 2021

(54) INTELLIGENT LOADING OF USER INTERFACE RESOURCES

(71) Applicant: SAP SE, Walldorf (DE)

(72) Inventor: Minesh Sapkota, Bangalore (IN)

(73) Assignee: SAP SE, Walldorf (DE)

(21) Appl. No.: 16/748,601

(22) Filed: Jan. 21, 2020

(51) Int. Cl. G06F 9/451; G06F 3/0482; G06F 11/34

(52) U.S. Cl. CPC G06F 9/451; G06F 11/3438; G06F 3/0482

(57) ABSTRACT

Intelligent loading of user interface resources is provided herein. Intelligent loading can include generating a usage pattern for a user interface. The usage pattern can be generated based on usage data gathered from use of the user interface. The usage data can be categorized by user, and user-specific usage patterns can be generated based on that user's usage data. Usage patterns can be generated via a machine-learning algorithm. The machine-learning algorithm can be trained on the usage data of a user interface. The machine-learning algorithm can be trained on usage data of a specific user of a user interface. The usage pattern can indicate a predictive order of use of resources in a user interface. Resources for a user interface can be loaded based on the usage pattern. Loading the resources based on a usage pattern can be performed in parallel to loading and using a user interface.

### BACKGROUND

The degree of functionality in user interfaces continues to increase at a high pace. Generally, the functionality must be loaded as part of the interface. However, current approaches to loading user interface functionality generally lead to slow or inefficient performance of the user interface. Thus, there is room for improvement.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a method comprises receiving a request to load user interface resources. The request can include an identifier of a target user interface. A usage pattern of the target user interface can be selected. One or more resources of the target user interface can be loaded based on the selected usage pattern.

In another embodiment, a method comprises receiving a request for a user interface, where the request includes an identifier of the user interface. The user interface can be loaded. Asynchronous to loading the user interface, the following steps can be performed. A usage pattern of the target user interface can be selected. One or more resources of the target user interface can be loaded based on the selected usage pattern. Selecting the usage pattern and loading the one or more resources can be performed separate from loading the user interface and at least in part performed while the user interface is available to a user. The resources can include respective code libraries including executable code configured to provide functionality in the user interface.

In another embodiment, a system comprises one or more memories, one or more processing units coupled to the one or more memories, and one or more computer-readable storage media storing instructions that, when loaded into the one or more memories, cause the one or more processing units to perform operations comprising the following: receiving a request for a user interface. The user interface can include a plurality of widgets respectively associated with a plurality of resources including executable program code. The request can include an identifier of the user interface and a user identifier of a user initiating the request. The user interface can be loaded. Loading the user interface can include loading the plurality of widgets of the user interface and presenting the user interface. In parallel to loading the user interface, a usage pattern can be accessed based on the user identifier and user interface identifier. The usage pattern can include an ordered set of resource identifiers identifying the plurality of resources, which can include executable program code, in the user interface. In parallel to loading the user interface, the plurality of resources, which can include executable program code, can be loaded based on the usage pattern. The resources, which can include executable program code, can be loaded in the order of the ordered set of resource identifiers in the usage pattern. The user interface can be presented to the user regardless of completion of loading of the plurality of resources including executable program code.

The foregoing and other objects, features, and advantages of the invention will become more apparent from the following detailed description, which proceeds with reference to the accompanying figures.

### BRIEF DESCRIPTION OF THE DRAWINGS

FIG. 1A is a block diagram of an example system implementing intelligent loading.

FIG. 1B is a block diagram of an example system arrangement implementing intelligent loading.

FIG. 2A is an entity diagram depicting user profiles, usage data, usage patterns, user interfaces, and applications arrangement.

FIG. 2B is an entity diagram depicting a user interface, widgets, resources, and usage pattern arrangement.

FIG. 3 is a flowchart of an example method of intelligently loading user interface resources.

FIG. 4 is an example arrangement illustrating how an intelligent loader can provide intelligent loading services to an application.

FIG. 5A is an exemplary application environment for an intelligent loading module.

FIG. 5B is an exemplary system environment for an intelligent loading module.

FIG. 5C is an exemplary network environment for an intelligent loading module.

FIG. 6 is a diagram of an example computing system in which described embodiments can be implemented.

FIG. 7 is an example cloud computing environment that can be used in conjunction with the technologies described herein.

### DETAILED DESCRIPTION

### Example 1—Overview

Generally, an application or user interface (UI) can load the UI resources or libraries of the UI using one of two approaches. The first approach is to load all the libraries required for the UI on the initial load of the UI, making the resources available whenever their associated controls are activated. This approach can cause a significant wait time in the initial load of the UI, which is often frustrating for users.

The second approach is to load the UI resources when it becomes needed, such as loading a resource once its associated control is activated. This approach is often termed lazy loading. While this approach reduces the initial load time of the UI, it still leaves a wait time for users when they activate functionality within the UI. Such wait times can still be significant and lead to user frustration, as is the case with complex or multilevel controls. Neither approach efficiently utilizes computing resources to reduce or minimize the wait time for a user when loading UI resources.

The intelligent loading functionality described herein generally alleviates or corrects these problems with UI resource loading. Generally, the intelligent loader can improve resource loading in a UI by loading resources in the background after a UI is provided to a user and generally before a user selects a control or other activation for a given resource. An intelligent loader can accomplish this by determining the next user actions and loading the appropriate resources before the user takes those actions.

Next actions of users can be known by incorporating intelligent technologies, such as machine learning. A UI is often used in a common or regular pattern by users. Determining the pattern of use can be achieved through machine learning algorithms trained on tracked UI usage data from users, and can thus predict the next control or activation a user is likely to engage in the UI.

For example, many users may utilize a UI in an application. Each user might have a pattern to their use of the UI (or application as a whole). Machine learning algorithms can be trained on such UI usage data and derive a pattern most frequently used by a given user, or an aggregate of users when using the UI or application. Thus, an intelligent resource loader can use the pattern to identify which action is likely next and accordingly which resources to load before the user makes a selection (or other activation) in the UI.

Accordingly, an intelligent loader can load the relevant resources before the resources are engaged, and need not wait until the user selects the UI control. Thus, wait times for UI controls can be avoided or reduced by loading the resources needed for UI controls based on patterns of UI usage, without any action taken by a user. Further, such intelligent loading generally improves system performance as well by providing an ordered and parallel process for loading necessary resources and UIs.

Intelligent loading functionality, and other resource loading and UI usage pattern determination functionality as described herein, can be provided in portal systems or other UI systems. Examples of such systems include: SAP Fiori™ technology and SAP UI5™ technology, both by SAP SE of Walldorf, Germany, and OpenUI5™ technology, maintained by SAP SE.

### Example 2—Example System that Performs Intelligent Loading of User Interface Resources Based on Usage Patterns

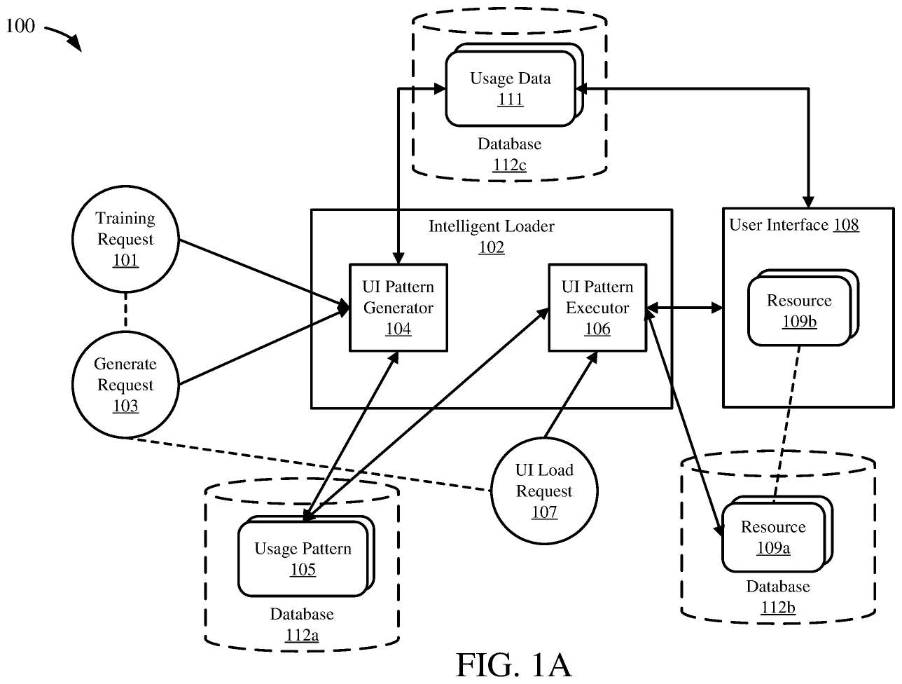

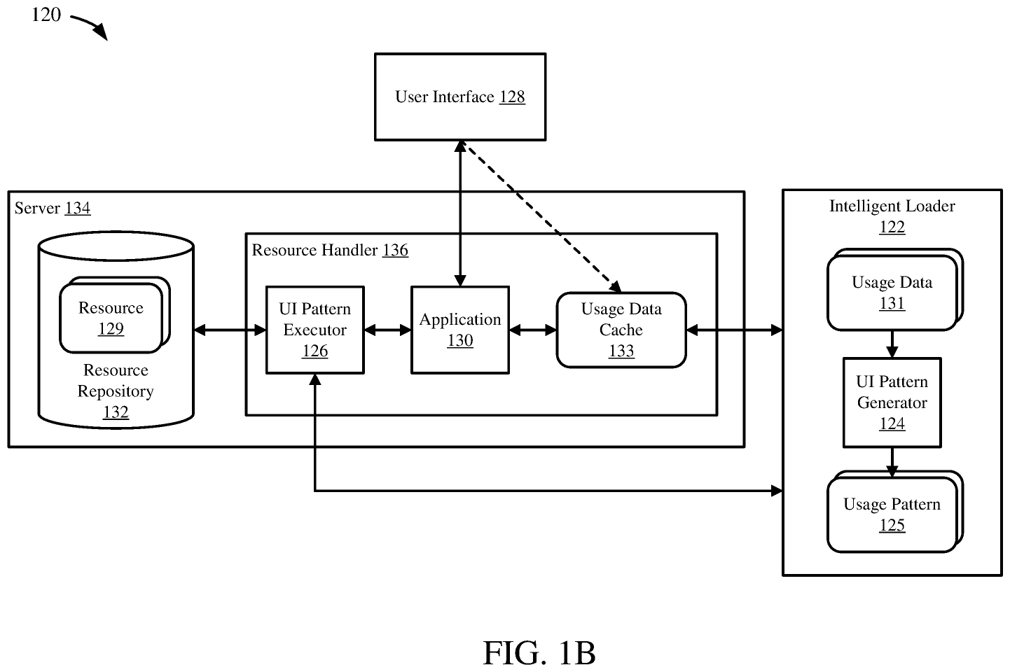

FIG. 1A is a block diagram of an example system 100 implementing intelligent loading. An intelligent loader 102 can generate one or more usage patterns 105, which can be used to intelligently load one or more resources 109a-b in a user interface 108. The intelligent loader 102 can provide intelligent loading functionality directly, or it may be integrated or partially integrated in an application, such as a software portal or other system with a user interface 108.

The intelligent loader 102 can receive a training request 101. The training request 101 can be a function call or can be made through an API or other interface of the intelligent loader 102. In some embodiments, the training request 101 can be received by the UI pattern generator 104. Generally, the training request 101 can initiate training of a machine-learning algorithm for identifying and generating usage patterns 105 of a user interface 108, such as implemented in the intelligent loader 102, and more specifically in some embodiments, the UI pattern generator 104.

The training request 101 can include one or more variables for training the intelligent loader 102 or, more specifically in some embodiments, the UI pattern generator 104. A training request 101 can identify usage data 111, such as through a reference ID, name, or other data identifier, and/or a location of usage data (e.g. a file or database, such as database 112c). Alternatively or additionally, a training request 101 can identify a particular user interface (e.g. 108) for which to train the UI pattern generator 104 to generate usage patterns (e.g. 105). Alternatively or additionally, a training request 101 can identify a particular user (e.g. user profile) for which to train the UI pattern generator 104 to generate usage patterns (e.g. 105). Identifying a particular user interface or user profile in a training request 101 can be used to further identify particular usage data 111 to use in training. For example, the training request 101 can specify to train the UI pattern generator 104 on usage data 111 for a particular user and/or a particular user interface.

The training request 101 can also include one or more configurable configuration settings or options, such as a value indicating a number of training cycles to perform, a threshold value for successful training, one or more settings used to display training results, or other settings related to machine-learning training.

The intelligent loader 102 can receive a generate request 103. The generate request 103 can be a function call or can be made through an API or other interface of the intelligent loader 102. In some embodiments, the generate request 103 can be received by the UI pattern generator 104. Generally, the generate request 103 can initiate generation of one or more usage patterns 105 of a user interface 108, such as implemented in the intelligent loader 102, and more specifically in some embodiments, the UI pattern generator 104. Once generated, a usage pattern 105 can be stored in a database or other data repository 112a (e.g. as a file in a location), accessible by the intelligent loader 102.

The generate request 103 can include one or more variables for generating the usage patterns 105. For example, the generate request 103 can include a reference to a user interface (e.g. 108) and/or a user (e.g. user profile). Such a reference can include a user interface identifier and/or user identifier. Additionally or alternatively, a generate request 103 can include an identifier (e.g. name) for the generated usage pattern 105 and/or a location for storing the usage pattern, such as database 112a.

The generate request 103 can also include one or more configurable configuration settings or options applicable to generating a usage pattern 105, such as a value indicating a format for the usage pattern, one or more weights or other variable factors for use in generating the usage pattern, or other generation factors.

In some cases, a training request 101 and a generate request 103 can be a single, combined request. In this way, the intelligent loader 102 can both learn and generate a usage pattern 105 based on usage data 111 in the same process.

In some cases, a training request 101 and/or a generate request 103 (including a combined training/generate request) can be sent or otherwise initiated based on a schedule or other triggering event. For example, a generate request 103 can be triggered at scheduled time intervals, such as once a week, once a month, on a particular day or at a particular time. Alternatively or additionally, for example, a training request 101 can be triggered whenever new usage data 111 is available, or when a threshold amount of new usage data is available (e.g. a given number of rows in a database, or the like).

The intelligent loader 102 can receive a UI load request 107. The UI load request 107 can be a function call or can be made through an API or other interface of the intelligent loader 102. In some embodiments, the UI load request 107 can be received by the UI pattern executor 106. Generally, the UI load request 107 can initiate loading of one or more resources 109a-b in a user interface 108 based on one or more usage patterns 105, such as can be implemented in the intelligent loader 102, and more specifically in some embodiments, the UI pattern executor 106.

The UI load request 107 can include one or more variables for loading the resources 109a-b of a user interface 108. For example, the UI load request 107 can include a reference to a user interface (e.g. 108) and/or a user (e.g. user profile), which can be used to select or identify a usage pattern 105 for use in loading the resources 109a-b in the user interface 108. Such a reference can include a user interface identifier and/or user identifier. Additionally or alternatively, a UI load request 107 can include an identifier (e.g. name) for one or more applicable usage patterns 105 and/or a location for retrieving the usage patterns, such as database 112a.

The UI load request 107 can also include one or more configurable configuration settings or options applicable to loading resources 109a-b, such as a location reference for retrieving the resources (e.g. database 112b) or other loading functionality.

In some cases, the UI load request 107 can include, trigger, or otherwise initiate a generate request 103 or a combination train/generate request 101, 103. In such cases, generally the generate 103 or train/generate request would be processed before the UI load request 107. For example, in such cases, generating a usage pattern 105 would generally occur before using the usage pattern to load the resources 109a-b in the user interface 108.

The intelligent loader 102 can load one or more resources 109a-b in a user interface 108 based on a usage pattern 105 of those resources in the user interface. For example, the UI pattern executor 106 can retrieve, read, process, or otherwise execute a usage pattern 105 to determine the order to load the one or more resources 109a from the resource database or repository 112b to the user interface 108 as local resources 109b. Loading the resources 109a-b into the user interface 108 generally includes copying a resource 109a from a repository 112b into local memory as a local resource 109b for the user interface 108. The UI pattern executor 106 can determine an order to load the resources 109a-b based on the usage pattern 105 for the user interface 108. In this way, the intelligent loader 102, through the UI pattern executor 106 for example, can load user interface resources 109a-b more efficiently by loading the resource most commonly used first, and then the resource most commonly used second, and so on, as delineated by the usage pattern 105 for the resources 109a-b of the user interface 108.

Usage data 111 can be tracked from the user interface 108 and stored in a database or other data repository 112c for use in generating one or more usage patterns 105 for the user interface. The usage data 111 can be obtained from a data tracker, which can identify the resources used or otherwise activated and the order in which they are used or otherwise activated. The usage data 111 can be gathered from across many uses of the user interface 108, and as performed by many different users. In some cases, the usage data 111 can track which user (e.g. user profile via a user ID) generated the usage data.

In some embodiments, the databases 112a-c can be a single database, separate databases, or some combination thereof.

In some embodiments, the intelligent loader 102 can be partially integrated with a user interface 108. For example, the UI pattern executor 106 can be integrated in a user interface 108 directly for executing a usage pattern for that user interface.

In practice, the systems shown herein, such as system 100, can vary in complexity, with additional functionality, more complex components, and the like. For example, there can be additional functionality within the intelligent loader 102. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the instructions for implementing the intelligent loader 102, the input, output and intermediate data of running the intelligent loader 102, or the databases 112a-c or the user interface 108, and the like can be stored in one or more computer-readable storage media or computer-readable storage devices. The technologies described herein can be generic to the specifics of operating systems or hardware and can be applied in any variety of environments to take advantage of the described features.

### Example 3—Additional Example System Arrangement that Performs Intelligent Loading of User Interface Resources Based on Usage Patterns

FIG. 1B is a block diagram of an example system arrangement 120 implementing intelligent loading. An intelligent loader 122 can generate one or more usage patterns 125, which can be used to intelligently load one or more resources 129 in a user interface 128, as similarly shown in FIG. 1A. The intelligent loader 122 can provide intelligent loading functionality directly, or it may be integrated or partially integrated in an application, such as a software portal or other system with a user interface 128.

A server 134 can include a resource repository 132 and/or a resource handler 136. A server 134 can further include an application 130, which the server can host or otherwise provide functionality to run the application. The resource repository can store or other house one or more resources, such as for an application 130 and/or a user interface 128. A server can further include a UI pattern executor 126 and/or a usage data cache 133. The resource handler 136 can host or otherwise manage, either in whole or in part, the application 130, the UI pattern executor 126, and/or the usage data cache 133. The application 130 can include a user interface 128, which can be hosted by the server 134 directly, or provided to a client device, such as by the server 134.

The usage data cache 133 can store usage data of the user interface 128 from the application 130. For example, the usage data cache 133 can include one or more usage data records indicating the user interface activations, selections, or other interactions (e.g. which widgets were activated by a user, and additionally in some cases, in what order) by a user in the user interface 128 of the application 130. The usage data cache 133 can provide the usage data to an intelligent loader 122, or, in some embodiments, be accessible by the intelligent loader. For example, a regular process (e.g. scheduled batch process) can transfer usage data from the usage data cache 133 to the intelligent loader 122 as usage data 131.

The intelligent loader 122 can include usage data 131, as received or obtained from the server 134 hosting the application 130. The intelligent loader 122 can include a UI pattern generator 124. The UI pattern generator 124 can process the usage data 131 to generate one or more usage patterns 125. The usage patterns 125 can indicate an order or pattern of resource 129 usage of the user interface 128 of the application 130.

The intelligent loader 122 can provide or make available the usage patterns 125 to the UI pattern executor 126. The UI pattern executor 126 can load the resources 129 for the user interface 128 based on the usage pattern 125. For example, the UI pattern executor 126 can read the usage pattern 125 to determine an order in which to load the resources 129 for the user interface 128. The UI pattern executor 126 can provide the resource details (e.g. name or identifier, etc.) to the resource handler 136 for loading of the resource 129. In some embodiments, the UI pattern executor 126 can access the resource repository 132 directly, and retrieve the resources 129, and further in some cases, load the resource itself.

In some embodiments, the usage pattern executor 126 can work in conjunction with the resource handler 136 to load the resources 129. For example, the UI pattern executor 126 can read the usage pattern 125 to determine a next resource to load 129, communicate the next resource to load to the resource handler 136, which can then load the resource. In some embodiments, the resource handler 136 can provide an environment within the server 134 to execute the UI pattern executor 126, the application 130, and/or the usage data cache 133. In some embodiments, the resource handler 136 can enable communication between the resource repository 132, the UI pattern executor 126, the application 130, and/or the usage data cache 133. In other embodiments, one or more of the resource repository 132, the UI pattern executor 126, the application 130, and/or the usage data cache 133 can communicate directly.

### Example 4—Example User, Usage Data, Usage Pattern, User Interface, and Application Relationship

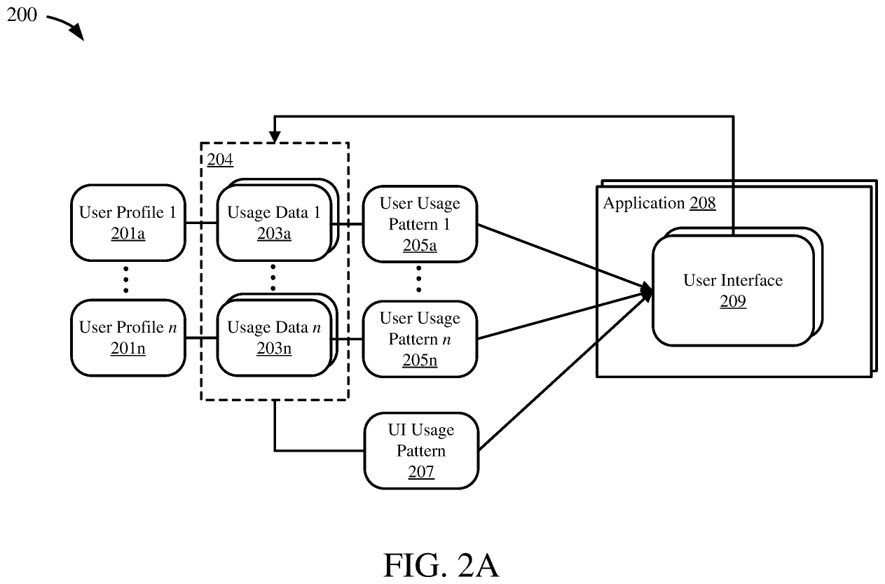

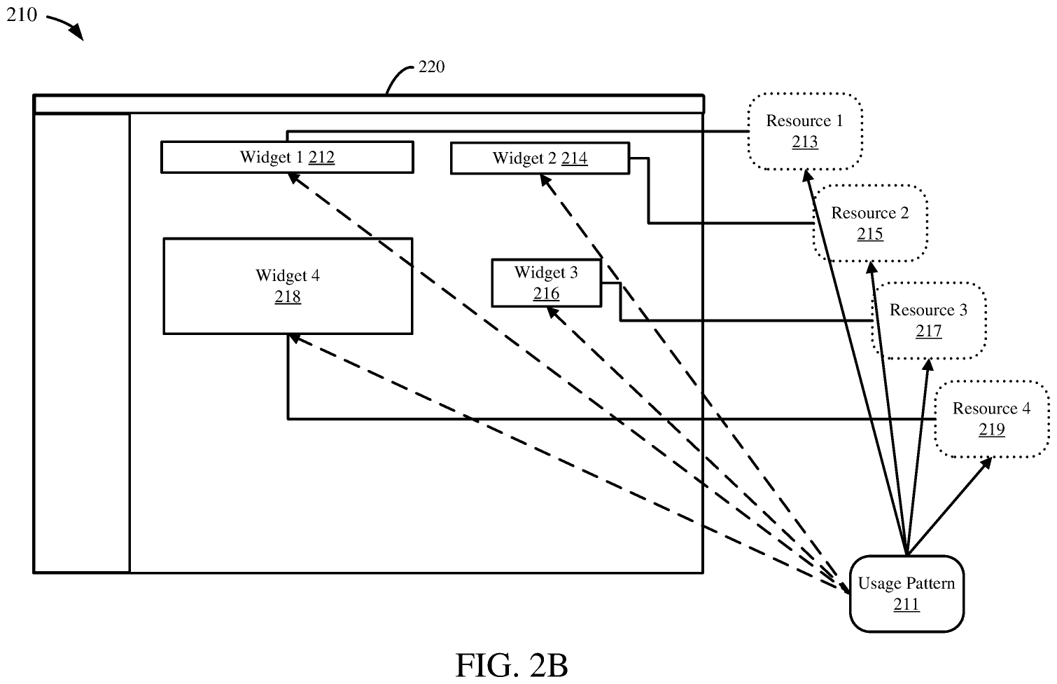

FIG. 2A is an entity diagram depicting user profiles, usage data, usage patterns, user interfaces, and applications arrangement 200. An intelligent loader, as described herein, can generate usage patterns 205a-n, 207 based on user profiles 201a-n, usage data 203a-n, and user interfaces 209 for applications 208, as similarly described and shown in FIGS. 1A-B.

An application 208 can include one or more user interfaces 209. In some embodiments, the application 208 and its user interfaces 209 can be accessed and used by one or more users, which can be represented by one or more user profiles, such as User Profiles 1-n 201a-n.

Usage data 204 can be obtained for a user interface 209. The usage data 204 can be associated with the user profile 201a-n which generated the usage data, such that User Profile 1 201a generated Usage Data 1 203a, which is associated with User Profile 1. For example, Usage Data 1 203a can include a user profile identifier for User Profile 1 201a. Multiple iterations of usage data can be obtained for a given user profile. Thus, for example, Usage Data 1 203a can include records of different instances or times when User Profile 1 201a used or otherwise engaged the user interface 209.

The usage data 204 can be used to generate usage patterns 205a-n, 207. Some or all of the usage data 204 obtained for the user interface 209 can be used to generate a UI usage pattern 207 for the user interface. The UI usage pattern 207 can represent the manner of use of the user interface 209 across all users 201a-n. For example, UI Usage Pattern 207 generally represents the order of actions or activations performed by all users in the user interface 209 based on the accumulated Usage Data 204 for this user interface. In some cases where user identity is not tracked, the UI usage pattern 207 can be generated based on the obtained usage data 204. The UI usage pattern 207 can generally be used as a base or default usage pattern for the user interface 209, in cases where other, more targeted user patterns are not available.

Usage patterns 203a-n can be generated for specific user profiles 201a-n. For example, User Usage Pattern 1 205a can be generated for User Profile 1 201a based on User 1's Usage Data 1 203a. This user usage pattern 205a can thus be customized or targeted to User 1's manner of using the user interface 209. For example, User Usage Pattern 1 205a generally represents the order of actions or activations User Profile 1 201a performs in the user interface 209 based on the accumulated Usage Data 1 203a for User 1 using this user interface.

In some cases, a user-specific usage pattern 205a-n can be more efficient for loading resources in a user interface 209 than a broad UI usage pattern 207.

Generally, the usage patterns 205a-n, 207 indicate a likely order of functionality a user may engage or request in a user interface 209. In this way, a usage pattern 205a-n, 207 can represent a prediction of user 201a-n actions in a user interface 209, and thus the usage pattern can direct the order in which to load resources for the user interface to ensure smooth functionality with reduced or minimal waiting by the user.

This arrangement can be repeated for each user interface 209 in an application 208, and for each application available in a system, and so on.

### Example 5—Example User Interface, Widget, Resource, and Usage Pattern Relationship

FIG. 2B is an entity diagram depicting user interface 220, widgets 212, 214, 216, 218, resources 213, 215, 217, 219, and usage pattern 211 arrangement 210. An intelligent loader, as described herein, can generate usage patterns 211 for a user interface 220 identifying widgets in the user interface 212, 214, 216, 218 and their associated resources used in the user interface 213, 215, 217, 219, as similarly described and shown in FIGS. 1A-B.

A user interface 220 can include one or more widgets, such as Widgets 1-4 212, 214, 216, 218. A widget 212, 214, 216, 218 can be associated a resource 213, 215, 217, 219, and in some cases multiple resources. For example, a widget such as Widget 1 212 can be a drop-down menu which can be associated with Resource 1 213, which can be a set of values for the drop-down menu. In this way, resources 213, 215, 217, 219 can provide data or functionality for a user interface 220 through widgets 212, 214, 216, 218 in the user interface.

A usage pattern 211 can include an identifier for the user interface 220 which it represents or to which it is otherwise associated. Generally, a usage pattern 211 includes a listing of the resources 213, 215, 217, 219 for a given user interface 220, and in some cases includes a list of the widgets 212, 214, 216, 218 for the given user interface. Generally, the listing of resources or widgets is an ordered listing, indicating a pattern of usage of the widgets in the user interface.

A usage pattern 211 for the user interface 220 can include references to the resources 213, 215, 217, 219 used by the user interface. For example, the usage pattern 211 can include a name or other identifier (e.g. function name or ID, database name or location, library name or ID, etc.) for Resource 1 213 of the user interface, and similarly for the other resources 215, 217, 219. Generally, the usage pattern 211 includes sufficient information regarding the resources 213, 215, 217, 219 to enable identification of the resources (e.g. for loading the resources into local memory of the user interface).

Alternatively or additionally, the usage pattern 211 can include references to the widgets 212, 214, 216, 218 in the user interface. For example, the usage pattern 211 can include a name or other identifier (e.g. widget or object name or ID, label name or ID, etc.) for Widget 1 212 of the user interface, and similarly for the other widgets 214, 216, 218. Generally, a widget 212, 214, 216, 218 can include information in the user interface 220 for identifying and/or accessing its associated resource(s) 213, 215, 217, 219. Thus, in some embodiments, a usage pattern 211 having references to widgets 212, 214, 216, 218 can identify the relevant resources 213, 215, 217, 219 via the widget references by accessing the widgets and obtaining their resource identifiers from the widget directly.

In this way, a usage pattern 211 which includes references to widgets, which can be alternative or additional to references to resources, can still be effectively used to load resources in a user interface even when resources are added to, removed from, or changed for a given widget.

### Example 6—Example Method that Generates and Executes Usage Patterns in Loading Resources of a User Interface

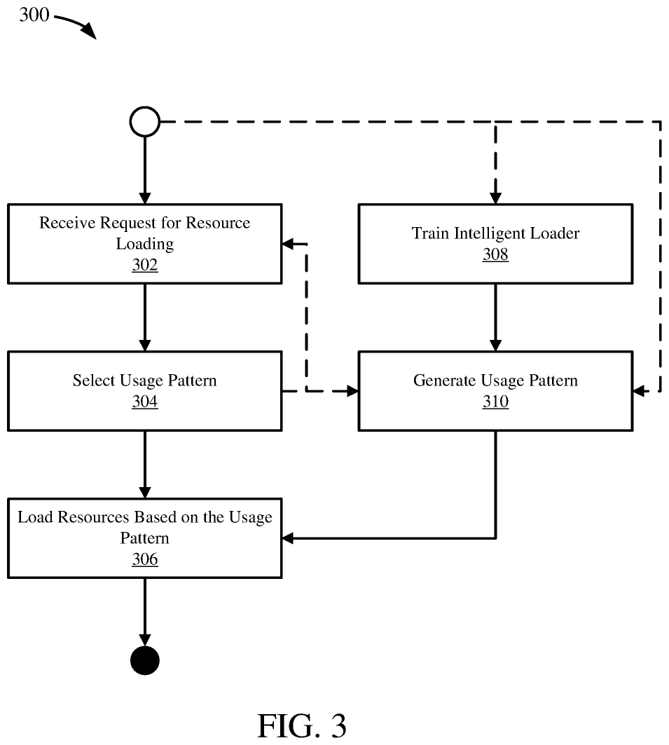

FIG. 3 is a flowchart of an example method 300 of intelligently loading user interface resources, and can be implemented, for example, by the systems described in FIGS. 1A-B and using data objects as described in FIGS. 2A-B.

At 302, a request for resource loading can be received. A resource loading request can include one or more variables or input arguments, such as described herein. For example, a resource loading request can include an identifier for a user interface, an identifier for a user, an identifier or location of a usage pattern or usage pattern repository, or other settings for intelligently loading resources in a user interface.

The resource loading request at 302 can originate as part of or related to a request for an application or a user interface. In some cases, the resource loading request at 302 can be received asynchronously or in parallel to a request for a user interface. In such cases, the user interface can be loaded or otherwise provided separately, generally in parallel to, the process 300 for loading the resources for the user interface.

At 304, a usage pattern can be selected. Selecting a usage pattern 304 can include accessing a usage pattern repository, such as a database or a data file, and retrieving a usage pattern file, record, or other data object. For example, a query or stored procedure can be executed against a database of usage patterns. Alternatively or additionally, a search for a usage pattern file can be executed against a usage pattern file location. In some embodiments, a usage pattern file or data object can be stored in conjunction with one or more user interface files, and such a file can be retrieved at 304 (e.g. without searching).

Selecting a usage pattern can include identifying a usage pattern applicable to the target user interface, as identified in the resource loading request at 302. For example, a usage pattern can be selected that is specific to the target user interface. Further, selecting a usage pattern can additionally include identifying a usage pattern specific to a user, as identified in the resource loading request at 302, or otherwise based on the request (e.g. the user that will be served the user interface). Generally, a usage pattern specific to a user can be more predictive of that user's use of the user interface than a general usage pattern for the user interface. Thus, selecting a usage pattern at 304 can include first attempting to obtain a usage pattern specific to the user and the user interface and, if such a user-specific usage pattern is not available, then obtaining a usage pattern not specific to a user but for the user interface (e.g. a default usage pattern for the user interface).

In some cases, selecting a usage pattern at 304 can include determining that a usage pattern is not available for the target user interface. In such cases, a usage pattern can be generated, as at 310, or an alternate form of resource loading, such as lazy loading, can be executed. In some embodiments, selecting a usage pattern at 304 can include requesting a usage pattern be generated (e.g. according to a particular user interface, and/or a particular user), such as at 310. Alternatively in such embodiments, receiving the loading request at 302 can be followed by generating a usage pattern at 310.

At 306, one or more resources can be loaded based on the selected usage pattern. Loading a resource at 306 can include retrieving a resource from a storage location and copying it into local memory, such as a local memory block allocated to and accessible by the user interface. In this way, a resource can be transferred into working memory for a user interface at 306.

Generally, loading the resources at 306 includes loading the resources for the user interface in an order as provided or determined by the usage pattern. For example, the usage pattern may provide an ordered list of resources for the user interface, and the resources can be loaded in the order of the list at 306. In other embodiments, the usage pattern can be analyzed to determine the order to load the resources. For example, resources can be loaded in the order of their probability of use as indicated in the usage pattern (e.g. the resource with the highest probability is loaded first, and so on).

Generally, the resources can be loaded sequentially at 306, in the order as provided by the usage pattern. In some embodiments, the resources can be loaded by separate, parallel processes. In such embodiments, the loading processes can be initiated in the order as provided in the usage pattern at 306.

Loading the resources at 306 can be performed in the background of a user interface, such as while the user interface is loading (e.g. separately, such as by a parallel process) and/or after the user interface is loaded and available to a user. In this way, the user interface can load and be available to the user, without needing to wait to load all the resources of the user interface. Further, the resources can be loaded in the background before a user selects or activates a given widget because the usage pattern can generally predict the likely order of resources likely to be needed to satisfy a user interaction or request, and so can load it without waiting for the user triggering action.

In some cases or embodiments, a usage pattern can be generated 308, 310 before a load request is received at 302, in response to receiving a load request at 302, or in response to determining an applicable usage pattern is not available at 304.

At 308, an intelligent loader can be trained. An intelligent loader, as described herein, can include a machine-learning algorithm to generate usage patterns, such as at 310. In such embodiments, the machine-learning algorithm can be trained to generate usage patterns based on collected usage data at 308. Training at 308 can include executing a training process via usage data for a user interface against the machine-learning algorithm to adapt the algorithm to generate usage patterns in accordance with the user interface usage data. For example, multiple training cycles or processing iterations using discrete records of usage data can be performed, which can include executing the machine-learning algorithm using a usage data record, comparing results of the algorithm to an expected or control output, and updating the machine-learning algorithm based on the differences between the input usage data record and the control or expected output.

Training the intelligent loader at 308 can include collecting, harvesting, gathering, or otherwise obtaining usage data of the user interface. In some cases, the usage data can be artificially generated usage data (e.g. automatically generated by a process). In other cases, the usage data can be collected from actual user interactions with the user interface, as described herein. Such real-world usage data can be stored for use in training, as at 308.

At 310, a usage pattern can be generated. Generating a usage pattern at 310 can include executing a machine-learning algorithm trained at 308 on usage data of a target user interface to produce a likely order of resource and/or widget interactions by a user. By training or otherwise using the usage data, a usage pattern generated at 310 can be based on historical user activity and can thus predict likely patterns of resource or widget use by a user in the user interface, thus indicating which order to load the resources in to reduce or minimize user wait time or lag in the user interface functionality.

A machine-learning algorithm used at 310 can include a supervised learning or unsupervised learning algorithm, a neural network, reinforced learning, or other machine-learning technique.

In some embodiments, training the machine-learning algorithm at 308 and generating a usage pattern at 310 can be integrated or combined. For example, processing new usage data through the intelligent loader's machine-learning algorithm can both update the algorithm based on the new usage data and result in a new usage pattern.

Generating a usage pattern at 310 can include storing the usage pattern generated, such as in a database or as a data file in a usage pattern repository.

Generating a usage pattern at 310 can include generating a user interface-specific usage pattern or a user-specific, UI-specific usage pattern for the target user interface.

In some embodiments, generating a usage pattern at 310 can include analyzing usage data, such as previously collected and described herein, using statistical analysis or other mathematical analysis, which may not include a machine-learning algorithm. In such embodiments, generating the usage pattern can include analyzing all or a subset of the available usage data for a user interface to determine trends or probabilities in the order of resource requests or usage.

In embodiments which do not use a machine-learning algorithm, the training at 308 can be skipped or otherwise excluded, in whole or in part (e.g. usage collection can still be performed).

Training at 308 and/or generating usage patterns at 310 can be performed in response to a request to load a user interface, or a request to load resources as at 302. Additionally or alternatively, training at 310 and generating at 308 can be performed in response to other triggers, such as collection of usage data or on a schedule. For example, after a threshold amount of new usage data is collected (e.g. since the last time training or generation was processed), training and generation 308, 310 can be performed based on the new usage data, and the generated usage pattern can be stored for later access and use. As another example, training and generation 308, 310 can be performed on a regular schedule, such as a batch process programmed to run at particular time intervals (e.g. once a week, once a month, etc.). In some embodiments, training and generation 308, 310 can be triggered by a system administrator or other technical user.

The method 300 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “receive” can also be described as “send” from a different perspective.

### Example 7—Example System Component Activity and Communication

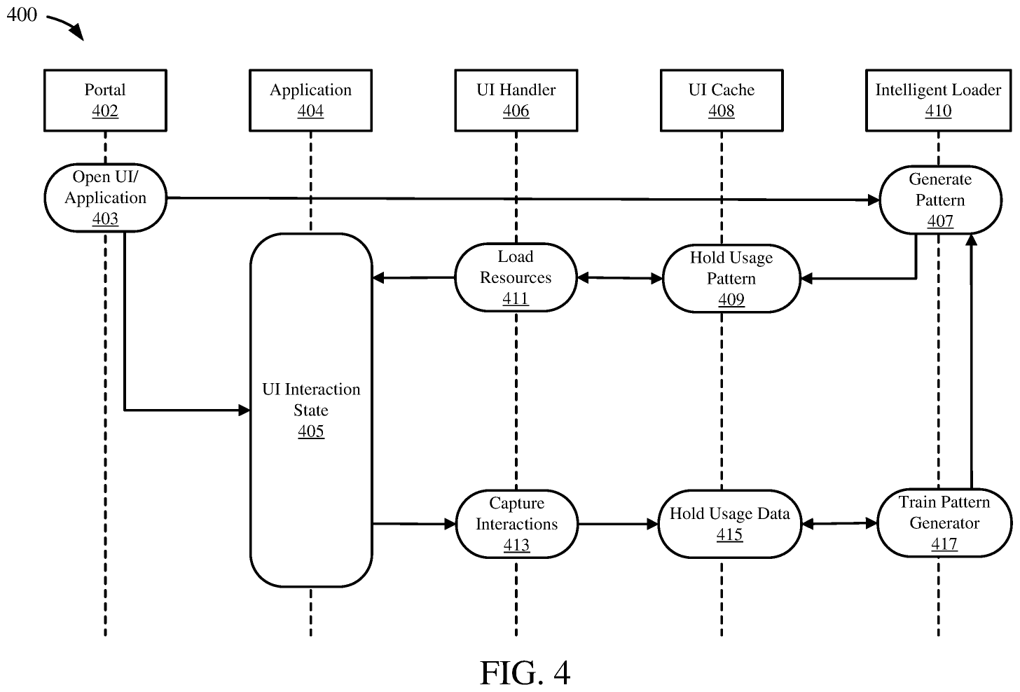

FIG. 4 is an example arrangement 400 illustrating how an intelligent loader 410 can provide intelligent loading services to an application 404. The components 402, 404, 406, 408, 410 can be similar to the systems shown in FIGS. 1A-B, and can utilize the data (e.g. usage data, usage patterns, etc.) as shown in FIGS. 2A-B and the process of FIG. 3.

A portal 402 can facilitate opening an application or a UI at 403. Opening the UI or application at 403 can include initiating a request to the application 404 to load and present a user interface for a user, as at the UI interaction state 405. The UI interaction state 405 can be facilitated by the application 404, and generally allows a user to engage, use, or otherwise interact with a UI. Generally, the UI interaction state 405 is an ongoing state where the UI is available to a user until the UI (or the application 404) is closed.

Further, additional to the request to load the UI, opening the UI/application at 403 can include initiating a request to generate a usage pattern 407 for the user interface. The intelligent loader 410 can facilitate generating the usage pattern 407, or otherwise providing the usage pattern for use in loading UI resources. The triggered request to generate a usage pattern 407 can be asynchronous or parallel to the request to load and present the UI 405.

Generally, as described herein, loading the resources of a UI can be done in parallel to presenting (and a user engaging with) the UI. In this way, resources can be intelligently loaded for a UI in the background, while the UI is available for use by a user.

Generating a pattern at 407 can result in providing the pattern to the UI cache 408, which generally holds (e.g. stores, maintains) the usage pattern 409. In this way, storing the usage pattern 409 can be facilitated by the UI cache 408.

Once a usage pattern is stored in the UI cache 408, the resources can be loaded based on the usage pattern 411. Loading the resources based on the usage pattern 411 can be facilitated by the UI handler 406. Generally, the UI handler 406 can load the resources 411 in an order determined by the usage pattern in the UI cache 408. In this way, the resources are likely to be loaded 411 before a user engages them in the UI in the interaction state 405.

In some cases, opening the UI/application 403 can initiate a request to load resources based on a usage pattern 411, directly to the UI handler 406, in place of generating a usage pattern 407. For example, if a usage pattern is already available 409, such as in the UI cache 408, the request to load resources made by opening the UI 403 can be sent directly to the UI handler 406 to load resources 411 based on the current usage pattern.

While the UI is presented to a user in the UI interaction state 405, interactions with the UI can be captured 413. Capturing user interactions 413 can be facilitated by the UI handler 406. The interactions captured 413 can be stored as usage data 415, such as in the UI cache 408.

The stored usage data 415 can be provided or otherwise accessed for training a pattern generator 417. Training the pattern generator 417 can be facilitated by the intelligent loader 410. Training the pattern generator 417 can result in the intelligent loader 410 being ready and capable of generating a usage pattern at 407. In some cases, upon completion of training 417, a new usage pattern may be generated automatically 407 based on the newly trained generator (e.g. intelligent loader 410).

In some embodiments, training the pattern generator 417 can be performed on a scheduled or routine basis. For example, a weekly batch process can access the usage data 415 and initiate training of the pattern generator 417 based on the accumulated usage data.

Generally, capturing interaction data 413 through training the pattern generator 417 is an asynchronous or parallel process to loading the resources 407, 409, 411. Both aspects can occur for an application 404 with an open UI 405.

In some embodiments, the portal 402 can be integrated with or otherwise part of the application 404. For example, opening the UI/application 403 can be moving from one screen to another screen 405 within an application. In such cases, two asynchronous requests can be triggered, as similarly for a separate portal 402, where one request opens the UI 405 and the other loads the resources according to a usage pattern 407, 409, 411.

### Example 8—Example Widgets and Resources

In any of the examples herein, a widget can include a selectable, activatable, usable, or other object in a user interface with which a user can engage. Generally, a widget can engage functionality in the user interface, either passively (without requiring user action) or actively (based on user action). For example, a widget can include a button, which can actively initiate a function call or other process when pressed by a user. As another example, a widget can include a drop-down menu, which can passively request values for the drop-down menu. In some cases, widgets can include automatic functionality, such as a clock display, automatic video or audio playback, or the like.

Further, a widget can include other data objects which may access or otherwise initiate functionality which may not be presented or otherwise be noticeable to a user. For example, a label may be associated with automatic functionality in the user interface.

Generally, a widget can be associated with one or more resources, which can be used to execute the functionality associated with the widget. For example, a menu may be associated with a database query resource (e.g. stored procedure) to retrieve values for the menu.

In any of the examples herein, a resource can comprise data, executable program code, or a combination thereof which can be used or executed by a user interface. Resource data can include data in a data file, database, registry, or other data storage or repository. Resource executable program code can include a program function or method, a library, or other executable object. For example, a resource associated with a widget can be a library providing program functionality for the widget, such as a process initiated by a button widget or a character counter for a text entry widget, or the like.

Therefore, the resources can comprise respective code libraries comprising executable code configured to provide functionality in the user interface (e.g., for respective of the widgets of the user interface). Such functionality can be interactive such as responding to activation (e.g., clicking, tapping, or the like) of the widget.

### Example 9—Example Usage Data and Usage Patterns

In any of the examples herein, usage data can include information regarding selection, activation, or other actions or engagements by a user of widgets, objects, or other items in a user interface. Usage data can include widget or object identifiers, resource identifiers, an identifier for the user interface, an identifier for a user (e.g. user profile) performing the actions in the user interface. Usage data can include information regarding the order or other relationship between actions taken by the user in the user interface. For example, the usage data can include an order of which actions were taken by the user in the user interface, such as which action (e.g. activation of a widget) was taken first, which action was taken second, and so on. In some cases, usage data can include aggregate or cumulative data, such as a count of the number of times a widget is activated or selected.

Usage data can include one or more records of data. For example, a usage data record can include all the usage information for a given session of usage of the user interface, as in, all the usage information for a particular instance of opening the user interface until the user interface is closed (or for a particular time period, etc.). Such a usage data record can be associated with a particular user (e.g. user profile) of the particular user interface, and/or associated with the particular user interface. Additionally or alternatively, a usage data record can include usage information for a particular user interface.

Usage data can be a data structure or collection of data structures capable of representing the actions of a user in a user interface within the data structure. For example, a usage data can include a database record (e.g. a row in a table), a data object instance (e.g. a usage data class having variables storing the usage information), a set of variables, or the like.

In any of the examples herein, a usage pattern can be a data file, data structure, or data object which represents a pattern of usage of resources, which can be associated with widgets or objects, in a user interface. Generally, a usage pattern can include a complete or partial list of resources, and/or widgets or other objects, in a user interface, and further indicate a predictive order of their use or activation by a user. For example, a usage pattern can indicate which resources, and/or widget or object, in a user interface is generally the first to be engaged by a user, which is generally the second to be engaged by a user, and so on. In some embodiments, the usage pattern can be an ordered list or set of resources, and/or widgets and other objects, in the user interface. In other embodiments, a usage pattern can be a related set of resources, and/or widgets or objects, with values or other variables associated with the data for the resource to indicate an order.

Generally, a usage pattern can be predictive of a user's actions in a user interface. For example, a usage pattern can include a probability of a resource, and/or widget or other object, being engaged by a user in a particular order (e.g. as the first, as the second, etc.).

A usage pattern can be a data file or a data record, such as in a database. For example, a usage pattern can be a JSON file delineating the resources, and/or widgets or other objects, in a user interface, and can further include resource identifying information, such as name, programmatic identifier, storage location, and so on. Such a file can store the resource information in order of their likely use (e.g. the first resource listed is likely the first engaged by a user, and so on).

A usage pattern can include resource identifying information and/or widget identifying information. A usage pattern including resource identifying information can provide such information for directly accessing and loading the resource. A usage pattern including widget identifying information can provide such information to access the widget in the user interface to obtain associated resource information for accessing and loading the resource. Widget identifying information in a usage pattern can be beneficial to decouple a usage pattern from the implementation of a user interface by allowing changes to a resource for a user interface without needing to update the usage pattern.

In some embodiments, a usage pattern can identify particular trends or combinations of resources. For example, a usage pattern can identify that Resource B is always requested after Resource A, but Resource A may not generally be requested at a particular place in the overall order for the user interface.

### Example 10—Intelligent Loading Module Environments

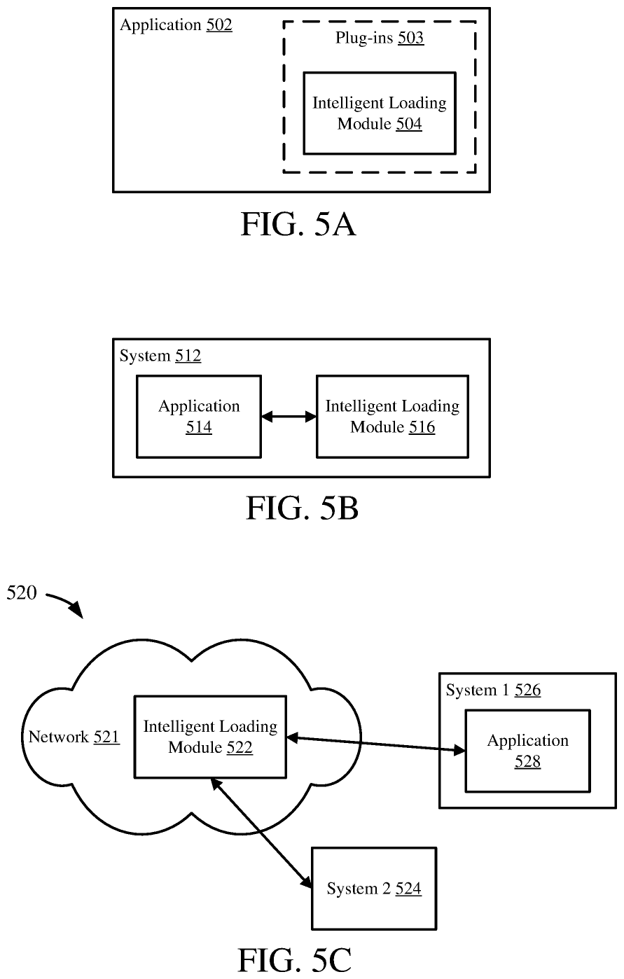

FIG. 5A is a schematic diagram depicting an application environment for an intelligent loading module 504, which may provide intelligent loading functionality, as described herein. An application 502, such as a software application running in a computing environment, may have one or more plug-ins 503 (or add-ins or other software extensions to programs) that add functionality to, or otherwise enhance, the application. The intelligent loading module 504 may be integrated with the application 502; for example, the intelligent loading module may be integrated as a plug-in. The intelligent loading module 504 may add functionality to the application 502 for intelligent loading functionality, which may be used to generate a user interface or otherwise provided to a user. For example, the application 502 may be a portal or UI-based application, and the intelligent loading module 504 may be integrated with the portal or UI-based application to provide intelligent loading functionality.

FIG. 5B is a schematic diagram depicting a system environment for an intelligent loading module 516, which may provide intelligent loading functionality, as described herein. The intelligent loading module 516 may be integrated with a computer system 512. The computer system 512 may include an operating system, or otherwise be a software platform, and the intelligent loading module 516 may be an application or service running in the operating system or platform, or the intelligent loading module may be integrated within the operating system or platform as a service or functionality provided through the operating system or platform. The system 512 may be a server or other networked computer or file system. Additionally or alternatively, the intelligent loading module 516 may communicate with and provide intelligent loading functionality, as described herein, to one or more applications 514, such as a portal or UI-based application, in the system 512.

FIG. 5C is a schematic diagram depicting a network environment 520 for an intelligent loading module 522, which may provide intelligent loading functionality, as described herein. The intelligent loading module 522 may be available on a network 521, or integrated with a system (such as from FIG. 5B) on a network. Such a network 521 may be a cloud network or a local network. The intelligent loading module 522 may be available as a service to other systems on the network 521 or that have access to the network (e.g., may be on-demand software or SaaS). For example, system 2 524 may be part of, or have access to, the network 521, and so can utilize intelligent loading functionality from the intelligent loading module 522. Additionally, system 1 526, which may be part of or have access to the network 521, may have one or more applications, such as application 528, that may utilize intelligent loading functionality from the intelligent loading module 522.

In these ways, the intelligent loading module 504, 516, 522 may be integrated into an application, a system, or a network, to provide intelligent loading functionality, or other usage pattern generation or resource loading functionality, as described herein.

### Example 11—Computing Systems

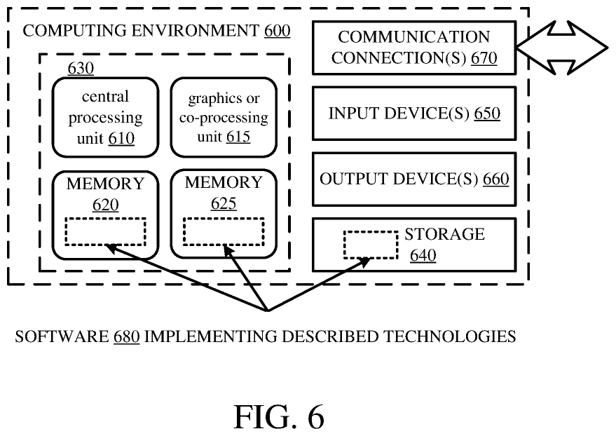

FIG. 6 depicts a generalized example of a suitable computing system 600 in which the described innovations may be implemented. The computing system 600 is not intended to suggest any limitation as to scope of use or functionality of the present disclosure, as the innovations may be implemented in diverse general-purpose or special-purpose computing systems.

With reference to FIG. 6, the computing system 600 includes one or more processing units 610, 615 and memory 620, 625. In FIG. 6, this basic configuration 630 is included within a dashed line. The processing units 610, 615 execute computer-executable instructions, such as for implementing components of the processes of FIGS. 3 and 4, the systems of FIGS. 1A-B and 5A-C, or the data, data representations, or data structures of FIGS. 2A-B. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s) 610, 615. The memory 620, 625 stores software 680 implementing one or more innovations described herein, in the form of computer-executable instructions suitable for execution by the processing unit(s) 610, 615. The memory 620, 625, may also store settings or settings characteristics, UI data, databases, data sets, usage data, or usage patterns, shown in FIGS. 2A-B, the systems shown in FIGS. 1A-B and 5A-C, or the steps of the processes shown in FIGS. 3 and 4.

A computing system 600 may have additional features. For example, the computing system 600 includes storage 640, one or more input devices 650, one or more output devices 660, and one or more communication connections 670. An interconnection mechanism (not shown) such as a bus, controller, or network interconnects the components of the computing system 600. Typically, operating system software (not shown) provides an operating environment for other software executing in the computing system 600, and coordinates activities of the components of the computing system 600.

The tangible storage 640 may be removable or non-removable, and includes magnetic disks, magnetic tapes or cassettes, CD-ROMs, DVDs, or any other medium which can be used to store information in a non-transitory way and which can be accessed within the computing system 600. The storage 640 stores instructions for the software 680 implementing one or more innovations described herein.

The input device(s) 650 may be a touch input device such as a keyboard, mouse, pen, or trackball, a voice input device, a scanning device, or another device that provides input to the computing system 600. The output device(s) 660 may be a display, printer, speaker, CD-writer, or another device that provides output from the computing system 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general purpose program, such as one or more lines of code in a larger or general purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 12—Cloud Computing Environment

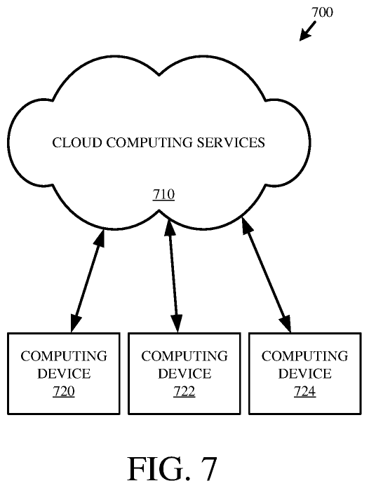

FIG. 7 depicts an example cloud computing environment 700 in which the described technologies can be implemented. The cloud computing environment 700 comprises cloud computing services 710. The cloud computing services 710 can comprise various types of cloud computing resources, such as computer servers, data storage repositories, networking resources, etc. The cloud computing services 710 can be centrally located (e.g., provided by a data center of a business or organization) or distributed (e.g., provided by various computing resources located at different locations, such as different data centers and/or located in different cities or countries).

The cloud computing services 710 are utilized by various types of computing devices (e.g., client computing devices), such as computing devices 720, 722, and 724. For example, the computing devices (e.g., 720, 722, and 724) can be computers (e.g., desktop or laptop computers), mobile devices (e.g., tablet computers or smart phones), or other types of computing devices. For example, the computing devices (e.g., 720, 722, and 724) can utilize the cloud computing services 710 to perform computing operations (e.g., data processing, data storage, and the like).

### Example 13—Implementations

Although the operations of some of the disclosed methods are described in a particular, sequential order for convenient presentation, it should be understood that this manner of description encompasses rearrangement, unless a particular ordering is required by specific language set forth. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 6, computer-readable storage media include memory 620 and 625, and storage 640. The term computer-readable storage media does not include signals and carrier waves. In addition, the term computer-readable storage media does not include communication connections (e.g., 670).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. It should be understood that the disclosed technology is not limited to any specific computer language or program. For instance, the disclosed technology can be implemented by software written in C++, Java, Perl, JavaScript, Python, Ruby, ABAP, SQL, Adobe Flash, or any other suitable programming language, or, in some examples, markup languages such as html or XML, or combinations of suitable programming languages and markup languages. Likewise, the disclosed technology is not limited to any particular computer or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

### Example 14—Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A method comprising:
receiving a request to load user interface resources, wherein the request comprises an identifier of a target user interface;
selecting a usage pattern of the target user interface; and
loading one or more resources of the target user interface based on the selected usage pattern.

2. The method of claim 1, wherein the usage pattern comprises one or more resource identifiers of the respective one or more resources of the target user interface.

3. The method of claim 1, wherein the usage pattern indicates an order for loading the one or more resources.

4. The method of claim 1, wherein the usage pattern comprises an ordered list of resource identifiers of the one or more resources of the target user interface.

5. The method of claim 1, wherein selecting the usage pattern comprises accessing a usage pattern repository and retrieving the usage pattern based on the target user interface identifier.

6. The method of claim 1, wherein selecting the usage pattern comprises obtaining a user identifier associated with the load request and selecting a user-specific usage pattern of the target user interface associated with the user identifier.

7. The method of claim 6, wherein selecting a usage pattern further comprises selecting a default usage pattern of the target user interface when the user-specific usage pattern is not available.

8. The method of claim 1, wherein loading the one or more resources comprises retrieving the one or more resources from a resource repository and storing the one or more resources in local memory of a user interface.

9. The method of claim 1, wherein the one or more resources are loaded sequentially in an order determined by the usage pattern.

10. The method of claim 1, further comprising:
generating the usage pattern based on usage data of the target user interface.

11. The method of claim 10, wherein the usage pattern is generated via a machine-learning algorithm.

12. The method of claim 11, wherein the machine-learning algorithm is trained via the usage data.

13. The method of claim 10, further comprising:
training a machine-learning algorithm to generate usage patterns, wherein the usage pattern is generated by the trained machine-learning algorithm.

14. The method of claim 13, further comprising:
tracking usage data of the target user interface, wherein the usage data comprises resource identifiers and an order of use of the one or more resources; and
wherein training the machine-learning algorithm comprises processing the usage data through the machine-learning algorithm through one or more training cycles.

15. The method of claim 14, wherein usage data is tracked over a period of time and the machine-learning algorithm is trained at the end of the period of time.

16. The method of claim 14, wherein records of the usage data are associated with users which generated the usage data, and the machine-learning algorithm is trained separately for the separate users.

17. The method of claim 1, further comprising:
loading the target user interface, wherein the target user interface comprises one or more references to the one or more resources.

18. The method of claim 1, wherein the target user interface is loaded in parallel to loading the one or more resources.

19. One or more non-transitory computer-readable storage media storing computer-executable instructions for causing a computing system to perform a method, the method comprising:
receiving a request for a user interface, wherein the request comprises an identifier of the user interface;
loading the user interface;
asynchronously to loading the user interface:
selecting a usage pattern of the target user interface; and
loading one or more resources of the target user interface based on the selected usage pattern, wherein selecting the usage pattern and loading the one or more resources are performed separate from loading the user interface and at least in part while the user interface is available to a user, and the one or more resources comprise respective code libraries comprising executable code configured to provide functionality in the user interface.

20. A system comprising:
one or more memories;
one or more processing units coupled to the one or more memories; and
one or more computer-readable storage media storing instructions that, when loaded into the one or more memories, cause the one or more processing units to perform operations comprising:
receiving a request for a user interface, wherein the user interface comprises a plurality of widgets respectively associated with a plurality of resources comprising executable program code, and wherein the request comprises an identifier of the user interface and a user identifier of a user initiating the request;
loading the user interface, wherein the loading comprises loading the plurality of widgets of the user interface and presenting the user interface;
in parallel to loading the user interface, accessing a usage pattern based on the user identifier and the user interface identifier, wherein the usage pattern comprises an ordered set of resource identifiers identifying the plurality of resources comprising executable program code in the user interface;
in parallel to loading the user interface, loading the plurality of resources comprising executable program code based on the usage pattern, wherein the plurality of resources comprising executable program code are loaded in the order of the ordered set of resource identifiers in the usage pattern; and
wherein the user interface is presented to the user regardless of completion of loading of the plurality of resources comprising executable program code.
